(19) United States
(12) Patent Application Publication
(10) Pub. No.: US 2016/0067719 A1
(43) Pub. Date: Mar. 10, 2016

(54) HYBRID CYCLONE MIST COLLECTOR

(71) Applicant: Ivo Fill, Grand Blanc, MI (US)

(72) Inventor: Ivo Fill, Grand Blanc, MI (US)

(21) Appl. No.: 14/479,603

(22) Filed: Sep. 8, 2014

(51) Int. Cl. B04C 5/02; B01D 45/16

(52) U.S. Cl. CPC B04C 5/02; B01D 45/16

(57) ABSTRACT

A hybrid cyclone mist collection device having a housing containing an inlet, an outlet and a cyclone body forming a wall extending about a vertical axis. The inlet brings mist-laden air through an airflow straightening area into the cyclone body in a tangential manner, creating a spiral flow path within the cyclone body. Mist-laden air entering the spiral flow path then moves downwardly through the cyclone body causing mist particles to collect on the wall of the cyclone body and then move downward due to the downward spiral airflow and gravity. At the bottom of the cyclone body the collected liquid enters an annular drain channel located beneath a vortex deflector plate and an annular shed sheet. A drain connected to the drain channel continuously removes the collected liquid from the housing and returns it to the machine tool station for reuse. The de-misted air exits the outlet and moves on to a central filter housing for final treatment.

### FIELD OF THE INVENTION

The present invention is related to components and systems for removing liquid and solid contaminants such as oils, coolants and particles dispersed in air which is collected from machining equipment.

### BACKGROUND OF THE INVENTION

Machining equipment used in manufacturing for cutting and forming metal typically employ cutting fluid (coolant) to cool and lubricate the cutting tools. The coolant is typically directed in jets at the cutting tools during machining, and the coolant draining from the part and the tools is collected and directed to filtration equipment for removal of contaminants and particle chips. The filtered coolant is then returned for reuse. Typically, the coolant is a type of oil or oil-water mix and as a result of the high speeds of the cutting tools, an oil or oil-water mist, which also contains solid particles and dusts from the machining operation, is often generated and dispersed into the air surrounding the cutting tools. In order to prevent the oil or oil-water mist from spreading around the facility, cutting operations are typically carried out within a contained area that includes a specific ventilation system for removing the oil or oil-water mist-laden air. The oil or oil-water mist (hereafter referred to as mist) needs to be removed from the air to prior to releasing the air into the surrounding environment.

The present invention seeks to provide a hybrid cyclone mist collection device that receives mist-laden air from a cutting operation environment and takes the initial steps of purifying the air by removing as much of the mist from the air as possible prior to further air treatment processes. It is desirable to provide a hybrid cyclone mist collection device that can be located near the machine tool station in order to prevent mist from collecting in ventilation components located further downstream of the cutting tool, as well as to reduce or prevent coolant evaporation within the ventilation system. It is further an object of the present invention to locate the hybrid cyclone mist collection tool near the cutting tool station in order to redirect collected coolant back to the cutting tool for re-use.

It is yet another object of the present invention to provide a hybrid cyclone mist collection device that reduces or eliminates coolant from leaving the outlet of the mist collection device.

### SUMMARY OF THE INVENTION

The present invention relates to a hybrid cyclone mist collection device having a housing containing an inlet and an outlet. The housing further includes a cyclone body forming a cylindrical wall extending about a vertical axis. Centered on the same axis is a vortex finder which extends partially downward into the cyclone body, and has an annular drip collar attached near its bottom. Mist-laden air flows into the cyclone body from the inlet in a tangential arrangement, creating a spiral flow path. Mist-laden air enters the spiral flow path and then moves downwardly within the cyclone body causing mist to collect on the interior surface of the cyclone body. The mist is typically composed of droplets of coolant which often also contain solid particulate matter. The mist collects on the interior surface of the cyclone body, agglomerates, and moves downward along the surface due to the downward spiral airflow as well as gravity.

At the bottom of the cyclone body is an annular drain channel that continuously receives the collected and agglomerated coolant that has moved downward along the cyclone body wall. The collected coolant is continuously removed through a drain. Located above the drain channel is a vortex deflector plate that has an annular shed sheet attached. The vortex deflector plate stops the downward spiral airflow and redirects it upward toward the vortex finder and outlet. When the system is turned off and all airflow stops, any coolant that may have accumulated on the vortex finder or drip collar will drip down onto the shed sheet and will then be directed into the drain channel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic representation of a hybrid cyclone mist collection system according to the present invention associated with a plurality of machine tools;

FIG. 2 is a pictorial view of return air plenum, preferably used in the system shown in FIG. 1;

FIG. 3 is an end view of a transition piece used with the system shown in FIG. 1;

FIG. 4 is a cross-sectional side view of a hybrid cyclone mist collection device;

FIG. 5 is an overhead cross-sectional plan view of a hybrid cyclone mist collection device;

FIG. 6 is a top overhead plan view of the solid top planar surface of the vortex deflector plate, the annular shed sheet, cyclone body portion and the annular drain channel,

FIG. 7A is a cross sectional schematic view of the raised portion of the cyclone body and vortex deflector plate according to the invention;

FIG. 7B is a cross sectional schematic view of the raised portion of the cyclone body and vortex deflector plate according to an alternate embodiment of the invention;

FIG. 7C is a cross sectional schematic view of the raised portion of the cyclone body and vortex deflector plate according to an alternate embodiment of the invention; and

FIG. 7D is a cross sectional schematic view of the raised portion of the cyclone body and vortex deflector plate according to an alternate embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

The present invention involves placing a single or a plurality of hybrid cyclone mist collection device(s), each installed at the machine tool station, combined with a central filter housing into which air from each hybrid cyclone mist collection device is drawn.

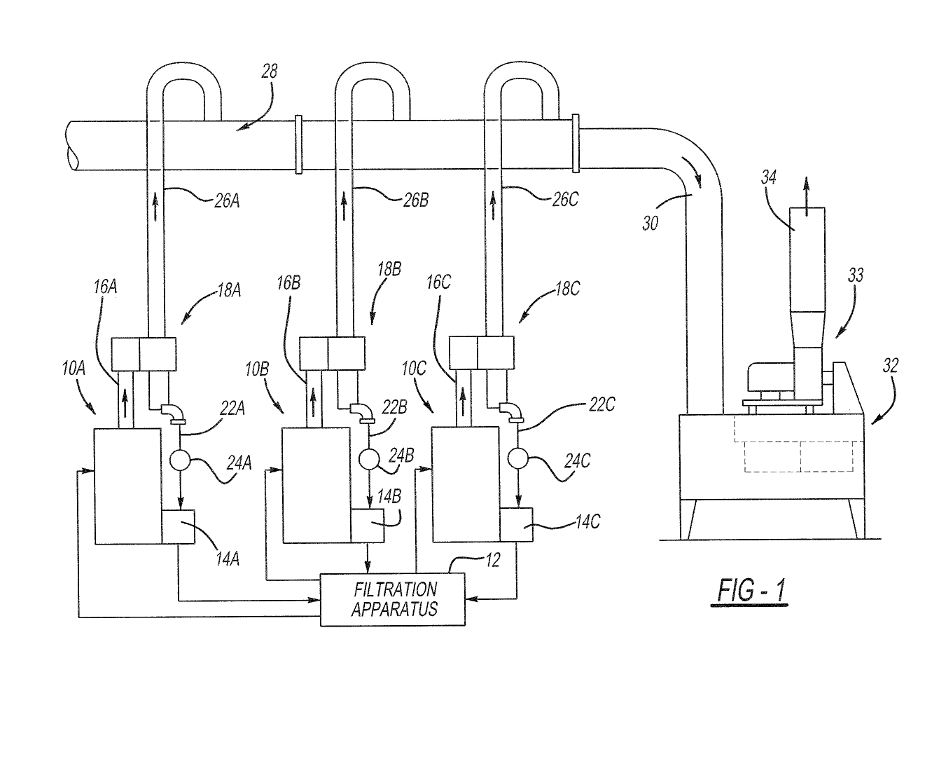

Referring to the drawings, and particularly FIG. 1, a series of machining equipment or machine tool stations 10A, 10B, 10C, are depicted. Each machine tool station 10A, 10B, 10C, is supplied with clean coolant from a filtration apparatus 12. The coolant is sprayed at the parts and cutting tools in the well known manner and drains down, along with the chips of material being cut as well as other machining debris, into a sump 14A, 14B, 14C where it can be pumped back to the filtration apparatus 12. Other arrangements may include a below-grade trench or above-grade trough to return the dirty coolant and debris to the filtration apparatus 12.

According to the present invention, the mist-laden air within the vicinity or within each tool station 10A, 10B, 10C is collected in a short duct 16A, 16B, 16C and drawn into an individual hybrid cyclone mist collection device 18A, 18B, 18C.

The collected coolant mist passes through the hybrid cyclone mist collection device 18A, 18B, 18C and is collected in an integrated annular drain channel 54 of the hybrid mist collection device 18A, 18B, 18C. Collected coolant and other debris in the annular drain channel 54 is directed via a drain 56, drain pipe 22A, 22B, 22C, and a drain valve 24A, 24B, 24C back to the dirty coolant collection space, such as sumps 14A, 14B, 14C, as indicated in FIG. 1.

The de-misted air is drawn up out of each hybrid cyclone mist collection device 18A, 18B, 18C via branch ducts 26A, 26B, 26C and connected to the top of air plenum 28. The air is drawn down the plenum 28 and through a main duct 30 connected to a conventional central filter housing 32. The filter housing 32 may include a replaceable HEPA or similar filter or filters, which remove any residual fine mist, fine particles, etc., prior to being discharged back into the ambient atmosphere via a stack 34. The filter housing also includes a fan 33 which pulls the air through the entire ventilation system.

It can be appreciated that by removing coolant mist from the air at each tool station, coolant evaporation throughout the entire ventilation system is minimized, and the airflow back to the central filter housing 32 is much less likely to become polluted with coolant vapor. Furthermore, by returning the collected coolant back to each tool station, the need for disposal of the collected coolant is avoided. Finally, the hybrid cyclone mist collection devices 18A, 18B, 18C are passive and do not require controls, etc., and only a single central filter housing 32 is required. Maintenance is held to a minimum and the system is much simplified over other types of systems.

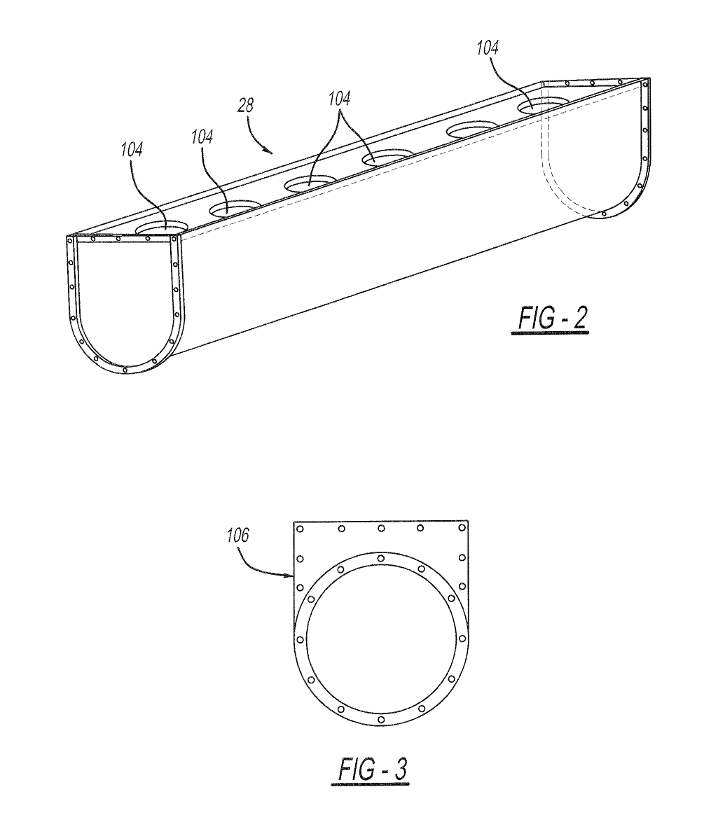

FIGS. 2 and 3 show the details of a preferred form of air return ducting, or the plenum 28, which features a U-shaped channel for the horizontal run. Openings 104 in a top wall allow connection of branch ducts 26 (shown in FIG. 1). A transition piece 106 allows connection to a round main duct 30 which then connects to the central filter housing 32. The U-shape provides the advantage of a round duct while enabling a flat surface for connection to the branch ducts 26.

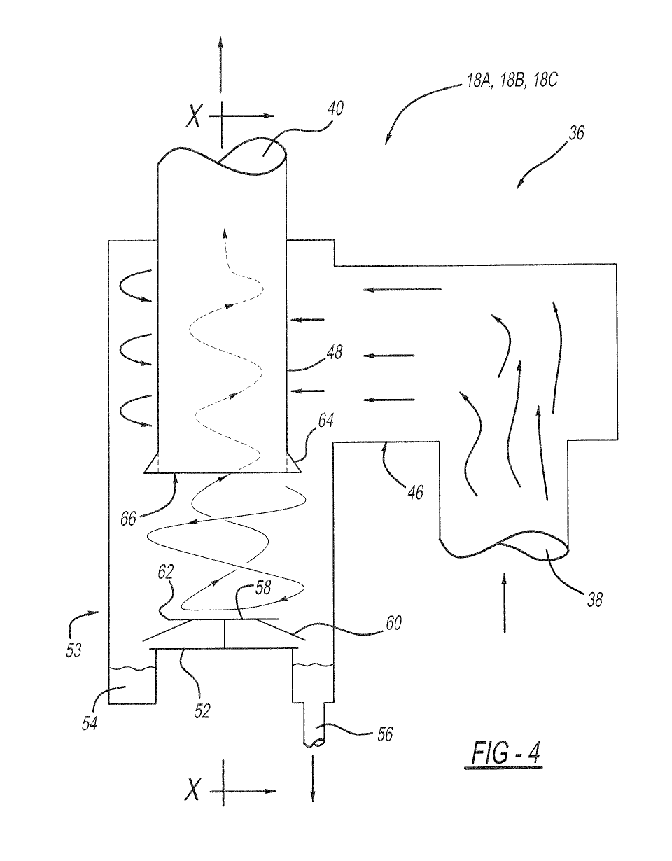

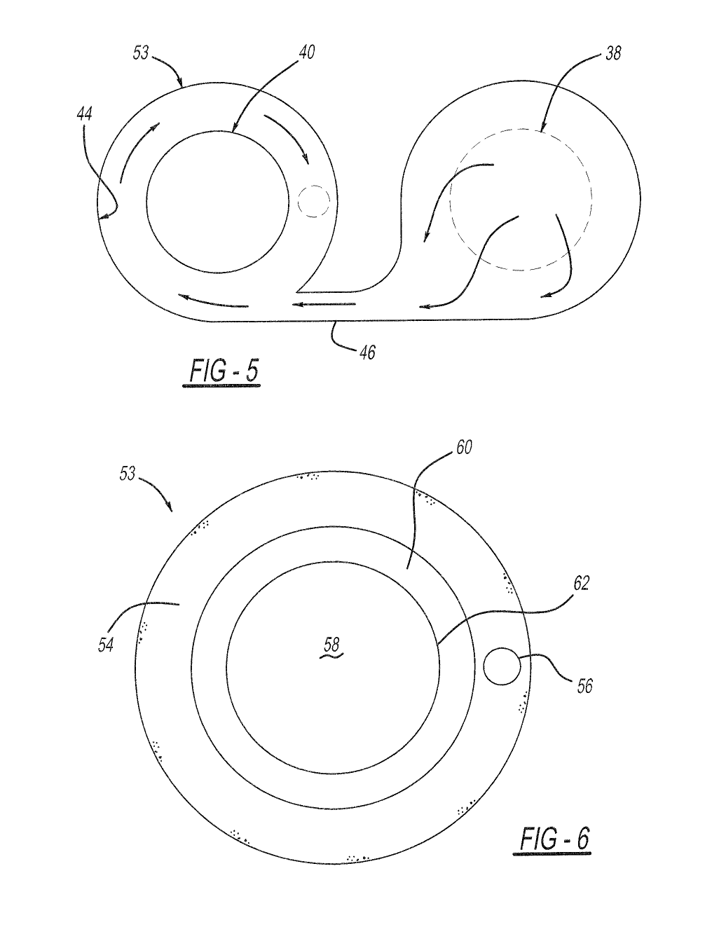

Referring now to FIGS. 4 and 5, the details of the individual hybrid cyclone mist collection devices 18A, 18B, 18C are shown. The hybrid cyclone mist collection devices 18A, 18B, 18C are each composed of a housing 36 containing an inlet 38 and outlet 40. The inlet 38 receives mist-laden air from the short ducts 16A, 16B, 16C while the outlet 40 receives de-misted air passing through the housing and exiting to the branch ducts 26A, 26B, 26C as shown in FIG. 1. Within the housing, between the inlet 38 and outlet 40, is a cyclone body 53 forming a cylindrical surface extending about a vertical axis X-X. Mist-laden air enters the inlet 38 and flows tangentially into the cyclone body 53, causing the mist-laden air to flow in a spiral flow path, causing mist to collect on the interior surface of the cyclone body 53. Between the inlet 38 and the entrance into the cyclone body 53, there is an airflow straightening area 46 formed in the housing. The airflow straightening area 46 is a narrowed area of the housing that concentrates and directs flow from the inlet 38 in a specific or straightened direction into the cyclone body 53 to achieve better airflow and improved mist capture characteristics in the cyclone body 53.

The spiral flow path within the cyclone body 53 terminates at a vortex finder 48. The vortex finder 48 is an elongated cylindrical tube connected to the outlet 40 that extends just below the bottom of the flow straightening area 46. The cyclone body 53 is configured to have a flow path that flows around the vortex finder 48. Air entering the cyclone body 53 tangentially creates a spiraling vortex flow path about the X-X axis that moves downward between the cyclone body wall and the vortex finder 48 toward a vortex deflector plate 58 located above the bottom of the cyclone body 53. The vortex deflector plate 58 is mounted above a raised portion 52 of the bottom of the cyclone body 53. The raised portion 52 is circumscribed by an annular drain channel 54 that is connected to a drain 56.

The raised bottom 52 of the cyclone body 53 prevents any collected coolant from migrating toward the center of the cyclone body floor, which would happen if the floor was flat. By raising the bottom and thus creating the drain channel 54, all the collected coolant, along with any solid particles, is directed into the drain 56.

The vortex finder 48 extends parallel with the vertical axis X-X and has an outside surface that connects to the cyclone body 53 and extends downward toward the vortex deflector plate 58. The vortex finder 48 includes a drip collar 64 formed on the outside surface of the vortex finder 48 and circumscribes an aperture 66 of the vortex finder 48 that leads to a passage through the vortex finder 48 into the outlet 40. The drip collar 64 directs any coolant that may have adhered to the outside surface of the vortex finder 48 away from the aperture 66 so that the coolant does not get sucked upward through the aperture 66 toward the outlet 40. The vortex deflector plate 58 is a solid planar surface. An annular shed sheet 60 extends at an angle below the vortex deflector plate 58. The annular shed sheet 60 is connected to the bottom side of the vortex deflector plate 58 and extends beyond an edge 62 of the vortex deflector plate 58. The annular shed sheet 60 extends downward toward the annular drain channel 54 at an angle such that any liquid located on the annular shed sheet 60 will flow downward and drip off of the annular shed sheet 60 into the annular drain channel 54. The circumference of the drip collar 64 is larger than the circumference of the vortex deflector plate 58. Upon shut down of the hybrid mist collection devices 18A, 18B, 18C liquid that has accumulated on the outer surface of the vortex finder 48 will migrate downward to the drip collar 64 and then drip downward onto the annular shed sheet 60.

As shown in FIG. 4, mist-laden air enters through the inlet 38 and is directed into the cyclone body 53 through the airflow straightening area 46. The airflow then travels through the spiral flow path within the cyclone body 53 where all or most of the mist, which includes both liquid and some small solid particles, adheres to the wall of the cyclone body 53. The mist that adheres to the wall agglomerates and the liquid continuously travels downward due to the downward spiral airflow and gravity into the annular drain channel 54.

One of the advantages of the present invention is that the vortex deflector plate 58 does not provide any areas where liquid or solid particles can become trapped or stuck and then get sucked upward toward the vortex finder 48. In the present invention, once the spiraling airflow contacts the vortex deflector plate 58, the airflow is deflected upward toward the vortex finder 48 at an angle that is inverse to the angle of the downward spiral airflow angle. This causes airflow deflected from the vortex deflector plate 58 to pass through the aperture 66 of the vortex finder 48 and exit through the outlet 40. The air that is deflected from the vortex deflector plate 58 has reduced or eliminated liquid and solid particles so the airflow leaving the hybrid cyclone mist collection device is as clean as possible before it enters the central filter housing 32. Liquid along with any solid particles collected in the annular drain channel 54 is removed through the drain 56 and then is returned to the machine tool station 10A, 10B, 10C or sump 14A, 14B, 14C for reuse as shown in FIG. 1. The present invention provides the advantage of allowing for individual hybrid cyclone mist collection devices located at each machine tool station 10A, 10B, 10C so that mist can be removed from the airflow prior to flowing onward to the central filter housing 32. The hybrid mist collection device 18A, 18B, 18C provides improved removal of coolant mist. This improvement is attributed to the use of an airflow straightening area 46, annular drip collar 64, a vortex deflector plate 58 with an attached annular shed sheet 60, and a raised bottom 52 in the cyclone body 53.

FIG. 6 is an enlarged view of the cyclone body 53, annular shed sheet 60 vortex deflector plate 58, annular drain channel 54 and drain 56. During operation of the hybrid cyclone mist collector particles of liquid will adhere to the wall of the cyclone body 53 and drip down to the annular channel 54 where the liquid is removed through the drain 56.

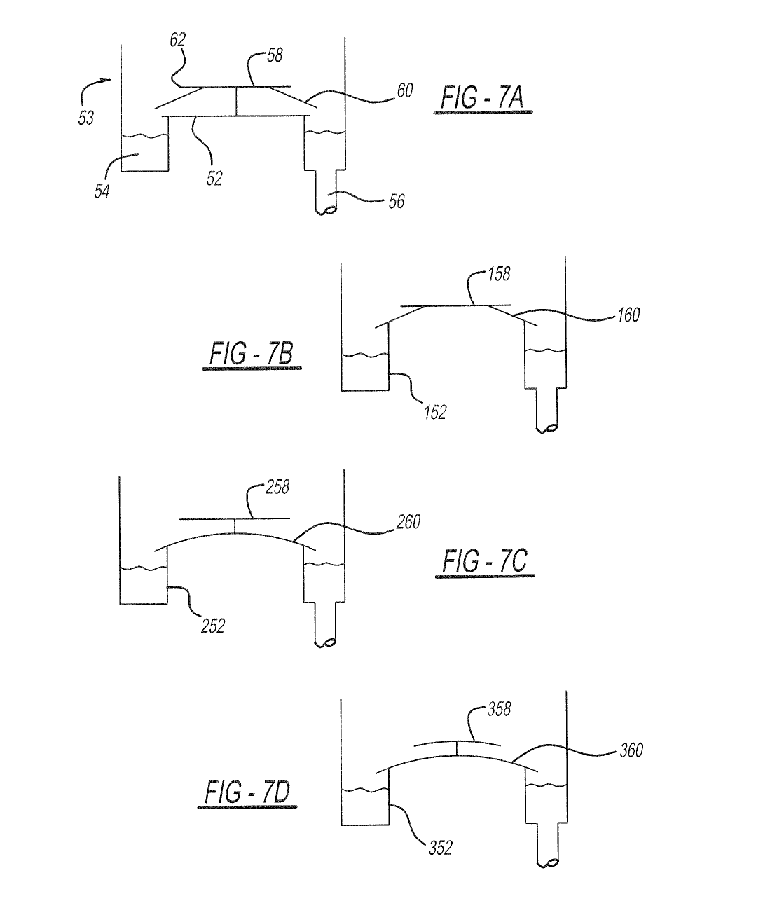

Referring now FIGS. 7A-7D, various configurations of the vortex deflector plate and annular shed sheet are shown. FIG. 7A shows the vortex deflector plate 58 and annular shed sheet 60 according to the present embodiment of the invention. FIG. 7B shows an alternate embodiment of the invention having a vortex deflector plate 158 connected to an annular shed sheet 160, which is connected directly to the top of a raised portion 152 of the cyclone body. This eliminates any space between the bottom side of the annular shed sheet 160 and the flat surface of the raised portion 52 as shown in FIG. 7A so that liquid cannot become trapped under the annular shed sheet 160 and vortex deflector plate 158. FIG. 7C shows an alternate embodiment of the invention having a vortex deflector plate 258 connected to an annular shed sheet 260 that has a rounded cross section and is positioned below and not connected directly to the vortex deflector plate 258. The rounded cross section causes any liquid on the surface to flow toward the annular drain channel and eliminate connection of the annular shed sheet 260 with the vortex deflector plate 258. Also the annular shed sheet 260 is connected to the top of a raised portion 252 of the cyclone body to provide the same advantages of FIG. 7B. FIG. 7D shows another alternate embodiment of the invention where an annular shed sheet 360 has a rounded cross-section and is connected to the top of a raised portion 352 of the cyclone body. This embodiment also has a vortex deflector plate 358 has a rounded cross-section both of which prevent liquid from accumulating on their surfaces due to the curvature of the plates.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A hybrid cyclone mist collection device comprising:
a housing containing an inlet and an outlet;
a cylindrical cyclone body forming a wall for containing a spiral flow path extending about a vertical axis and connected to the inlet where mist-laden air flows in from the inlet and flows tangentially into the spiral flow path, downwardly through said spiral flow path causing mist and particles dispersed in said air to collect on said wall of said cyclone body;
a vortex deflector plate, wherein an annular shed sheet is attached to the said vortex deflector plate and said outlet is located above said vortex deflector plate and receives de-misted air flowing out of said spiral flow path; and
a drain channel formed in said cyclone body below said vortex deflector plate and said annular shed sheet.

2. The hybrid cyclone mist collection device of claim 1, wherein said vortex deflector plate has a solid planar top surface.

3. The hybrid cyclone mist collection device of claim 1, wherein said annular shed sheet is connected at an angle to the bottom of the vortex deflector plate in order to form a sloped surface for causing particles and liquid to slide down the sloped surface and drop into said drain channel.

4. The hybrid cyclone mist collection device of claim 3, wherein said annular shed sheet connects to an edge of the vortex deflector plate.

5. The hybrid cyclone mist collection device of claim 1, wherein said annular shed sheet connects to an edge of the vortex deflector plate.

6. The hybrid cyclone mist collection device of claim 1, wherein said annular shed sheet is connected at an angle to the bottom of said vortex deflector plate in order to form a sloped surface, wherein a portion of the bottom surface of said vortex deflector plate creates an overhang surface area that overhangs a portion of said annular shed sheet.

7. The hybrid cyclone mist collection device of claim 1 further comprising a vortex finder connected to said outlet and extending downward toward said vortex deflector plate.

8. The hybrid cyclone mist collection device of claim 7, wherein the cyclone body circumscribes said vortex finder.

9. The hybrid cyclone mist collection device of claim 7, wherein the vortex finder further includes a drip collar that prevents liquid from migrating into the vortex finder.

10. The hybrid cyclone mist collection device of claim 1 further comprising an airflow straightening area formed in said housing between said inlet and said cyclone body.

11. The hybrid cyclone mist collection device of claim 1, wherein the bottom of said cyclone body includes a portion of the floor that is raised and topped with a lower plate.

12. The hybrid cyclone mist collection device of claim 1 further comprising an annular drain channel at the bottom of said cyclone body, below said vortex deflector plate and said annular shed sheet, where said annular drain channel is connected to said drain.

13. A hybrid cyclone mist collection device comprising:
a housing containing an inlet and an outlet;
a cylindrical cyclone body forming a wall for containing a spiral flow path extending about a vertical axis and connected to the inlet where mist-laden air flows in from the inlet and flows tangentially into the spiral flow path, downwardly through said spiral flow path causing mist and particles dispersed in said air to collect on said wall of said cyclone body;
a vortex deflector plate, wherein an annular shed sheet is attached to the said vortex deflector plate and said outlet is located above said vortex deflector plate and receives de-misted air flowing out of said spiral flow path;
a drain channel formed in bottom of said cyclone body below said vortex deflector plate and said annular shed sheet;
a bottom of said housing that includes a raised portion of said cyclone body bottom topped with a lower plate;
an annular drain channel located adjacent to and surrounding said raised cyclone bottom; and
a drain connected to said annular drain channel for removing collected liquid and particles from said housing.

14. The hybrid cyclone mist collection device of claim 13, wherein said vortex deflector plate has a solid planar top surface.

15. The hybrid cyclone mist collection device of claim 13, wherein said annular shed sheet is connected at an angle to the bottom of the vortex deflector plate in order to form a sloped surface for causing particles and liquid to slide down the sloped surface and drop into said drain channel.

16. The hybrid cyclone mist collection device of claim 15, wherein said annular shed sheet connects to an edge of the vortex deflector plate.

17. The hybrid cyclone mist collection device of claim 13, wherein said annular shed sheet connects to an edge of the vortex deflector plate.

18. The hybrid cyclone mist collection device of claim 13, wherein said annular shed sheet is connected at an angle to the bottom of said vortex deflector plate in order to form a sloped surface, wherein a portion of the bottom surface of said vortex deflector plate creates an overhang surface area that overhangs a portion of said annular shed sheet.

19. The hybrid cyclone mist collection device of claim 13 further comprising a vortex finder connected to said outlet and extending downward toward said vortex deflector plate.

20. The hybrid cyclone mist collection device of claim 19, wherein the cyclone body circumscribes said vortex finder.

21. The hybrid cyclone mist collection device of claim 19, wherein the vortex finder further includes a drip collar that prevents liquid from migrating into the vortex finder.

22. The hybrid cyclone mist collection device of claim 13 further comprising an airflow straightening area formed in said housing between said inlet and said cyclone body.
